(19) United States
(12) Patent Application Publication
(10) Pub. No.: US 2003/0037799 A1
(43) Pub. Date: Feb. 27, 2003

(54) Cleaning apparatus and method of cleaning using an ultrasonically excited cleaning fluid

(76) Inventors: Brett G. Clark, Whites Creek, TN (US); Jason Thomas Troyer, Brentwood, TN (US); David Wayne Sellers, Franklin, TN (US)

Correspondence Address: BANNER & WITCOFF, 1001 G STREET N W, SUITE 1100, WASHINGTON, DC, 20001, US

(21) Appl. No.: 09/933,136

(22) Filed: Aug. 21, 2001

(51) Int. Cl. B08B 3/12

(52) U.S. Cl. 134/1; 134/10; 134/111; 134/186; 134/42; 134/201

(57) ABSTRACT

A cleaning apparatus uses an ultrasonically excited cleaning fluid to clean an object disposed in a cleaning chamber that is substantially isolated from a surrounding environment. The apparatus is particularly suited to cleaning a portion of an elongate member, especially (but not necessarily only) an intermediate (i.e., a portion excluding a distal end portion) portion thereof. In one example, the cleaning apparatus is usable to clean only an intermediate portion of an optical fiber stripped of its coating. The cleaning fluid may be, for example and without limitation, an alcohol such as isopropyl alcohol, or acetone. The cleaning fluid may be circulated in a closed circuit. The closed circuit may include one or more of a fluid pump, a vacuum device for further urging the fluid through the system, and a fluid filter for cleaning the used fluid of at least some contaminants before it is reused.

### FIELD OF THE INVENTION

The present invention relates to a cleaning apparatus using an ultrasonically excited cleaning fluid and a method of cleaning using an ultrasonically excited cleaning fluid, particularly with respect to cleaning optical fibers.

### BACKGROUND OF THE INVENTION

Generally, preparing optical fibers for splicing is a three-step process of stripping a coating from a fiber, cleaning the stripped portion of the fiber, and cleaving (i.e., cutting) the end of the fiber to provide a clean end surface for splicing.

Conventionally, the stripped portion of the fiber may be cleaned by wiping it with a cloth or other fiber or thread structure that is moistened with alcohol or the like. See, for example, U.S. Pat. No. 5,469,611 to Sasaki et al. However, physical contact with the stripped portion of the fiber is undesirable because of the risk of damaging the fiber, especially scratching the peripheral surface of the fiber.

Optical fibers have sometimes been cleaned using an ultrasonically excited cleaning fluid in a tub or other container open to the ambient atmosphere. The tip of an optical fiber is dipped into the tub, and the cleaning fluid is ultrasonically excited by a high frequency driving source to accomplish cleaning. In some conventional arrangements, the optical fiber is moved vertically to dip the fiber into the tub. Once cleaned, the fiber tip is then removed from the tub.

However, the use of an open tub or the like creates certain problems. For example, because the tub is open to the ambient atmosphere, the cleaning fluid may become easily contaminated by environmental pollutants, which in turn contaminates the optical fiber dipped therein. Also, many cleaning fluids, such as alcohols, are volatile and tend to evaporate quickly from open cleaning tubs and must be replaced. Furthermore, the fumes may be very flammable and generally add to the level of airborne contaminants in the workplace.

Finally, the use of a tub or the like means that the overall dimensions of the conventional processing apparatus are relatively large because processing steps take place both in a generally horizontal plane (as components are moved relative to each other) and in a generally vertical plane (to accommodate dipping into the cleaning tub).

### SUMMARY OF THE INVENTION

In view of the foregoing, it is desirable to provide an ultrasonic cleaning apparatus that avoids the conventional problems of using an open tub of cleaning fluid.

Accordingly, the present invention is directed in part to a cleaning apparatus including at least one substantially closed cleaning chamber, at least one ultrasonic excitation source arranged to ultrasonically excite cleaning fluid in the at least one cleaning chamber, and a fluid feeding system for moving cleaning fluid into and out of the at least one cleaning chamber.

A cleaning chamber according to the present invention is substantially closed to the surrounding atmosphere during cleaning. In one example, the cleaning chamber is defined by first and second selectively engageable chamber parts that together define the cleaning chamber. The apparatus may include a drive mechanism for moving the chamber parts into engagement, so that the cleaning process can be partly or fully automated. One of the chamber parts may be provided with a cleaning fluid inlet port, and one of the chamber parts may be provided with a cleaning fluid outlet port. In some cases, the inlet port and the outlet port are provided in opposite chamber parts. Furthermore, the number of inlet ports provided may be different from the number of outlet ports provided.

The fluid feeding system may include a fluid pump for moving a cleaning fluid into and out of a cleaning chamber of the apparatus. In one example, the fluid feeding system is a closed circuit, so that the cleaning fluid is recycled. In this case, it is desirable to provide a fluid filter in the fluid circuit in order to help clean the cleaning fluid exiting a cleaning chamber. In addition, it may be useful to provide a vacuum device in the circuit to further urge the cleaning fluid through the system, in addition to or instead of the fluid pump.

A method of cleaning a portion of an elongate member includes disposing the portion of the member in a cleaning chamber and cleaning the portion of the member with an ultrasonically excited cleaning fluid introduced into the cleaning chamber. Preferably, the cleaning chamber is substantially isolated from a surrounding environment so that loss of cleaning fluid through evaporation and contamination of the workplace environment are reduced. In a particular example, the elongate member is an optical fiber. Furthermore, the portion of the elongate member being cleaned may preferably be an intermediate portion of the member, excluding a distal end portion of the member.

Preferably, the elongate member (such as an optical fiber) is subjected to various processing steps (e.g., stripping, cleaning (using the present invention), and splicing) while being maintained in substantially the same planar position, such as in a substantially horizontal plane. In doing so, the overall process apparatus can be made desirably smaller because it is unnecessary to accommodate moving the elongate member into a different position (such as into a vertical position) to use a conventional ultrasonic cleaning tub.

### BRIEF DESCRIPTION OF THE DRAWINGS

The present invention disclosed and claimed herein will be ever better understood with reference to the appended drawings, in which:

FIGS. 1(a)-1(c) illustrate constituent components of a first chamber part of a cleaning apparatus according to the present invention, FIGS. 1(a) and 1(b)) being generally plan views and FIG. 1(c) being a perspective view;

FIGS. 2(a) and 2(b) illustrate opposite faces of a first constituent component of a second chamber part of a cleaning apparatus according to the present invention;

FIG. 3 illustrates a second constituent component of a second chamber part of a cleaning apparatus according to the present invention;

FIG. 4 is a schematic illustration of one example of a cleaning apparatus according to the present invention;

FIG. 5 is an exploded view of a cleaning apparatus according to the present invention;

FIGS. 6(a)-6(e) schematically illustrate operation of a cleaning apparatus according to the present invention; and

FIG. 7 illustrates an embodiment of the present invention in which first and second chamber parts are hingedly attached and selectively engageable with each other.

### DETAILED DESCRIPTION OF THE PRESENT INVENTION

As mentioned hereinabove, the present invention is directed to a method and apparatus for cleaning an elongate member. By way of example without being limiting, the present invention will be described with reference to cleaning an optical fiber.

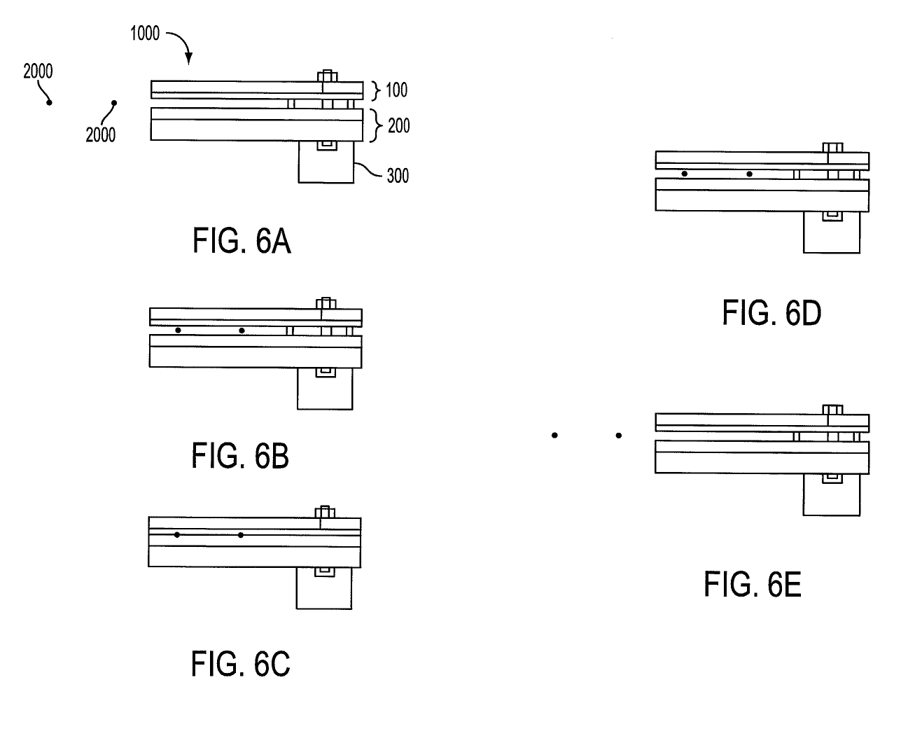

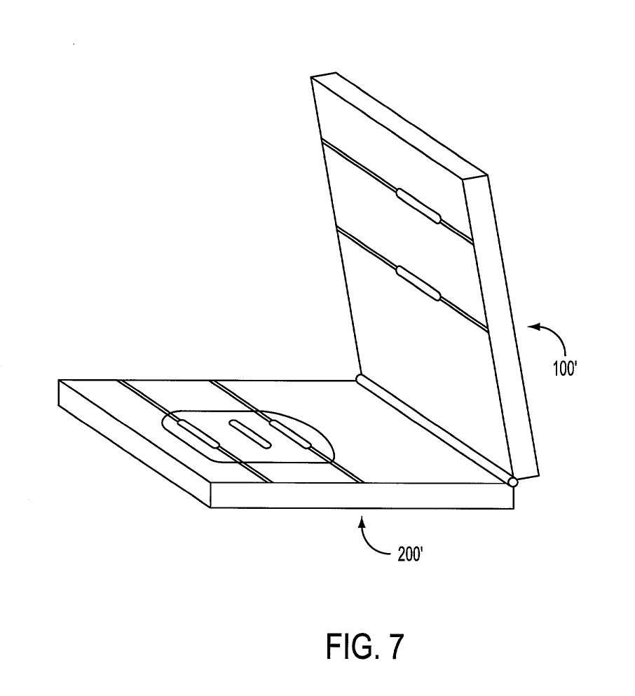

As seen in, for example, FIGS. 6(a)-6(e), cleaning apparatus 1000 includes first chamber part 100 and second chamber part 200. First and second chamber parts 100, 200 are selectively movable relative to each other between open and closed states, and together (in their closed state) at least partly define a cleaning chamber according to the present invention (described in more detail below).

In one example of the present invention, first and second chamber parts 100, 200 are independent members. In this case, cleaning apparatus 1000 may include an appropriately constructed actuator mechanism 300 for selectively moving the first and second chamber parts 100, 200 relative to each other between open and closed states. One example of an actuator mechanism is a conventional pneumatically-actuated push-pull rod actuator 302 that operates to selectively pull together first and second chamber parts 100, 200 to closed state and to selectively push them apart to an open state.

In another example of the present invention generally illustrated in FIG. 7, first and second chamber parts 100′, 200′ may be hingedly attached to each other instead of being independent parts. A suitable actuator mechanism (not shown) may be used with that arrangement as well to hingedly move the first and second chamber parts 100′, 200′ into and out of opposition with each other.

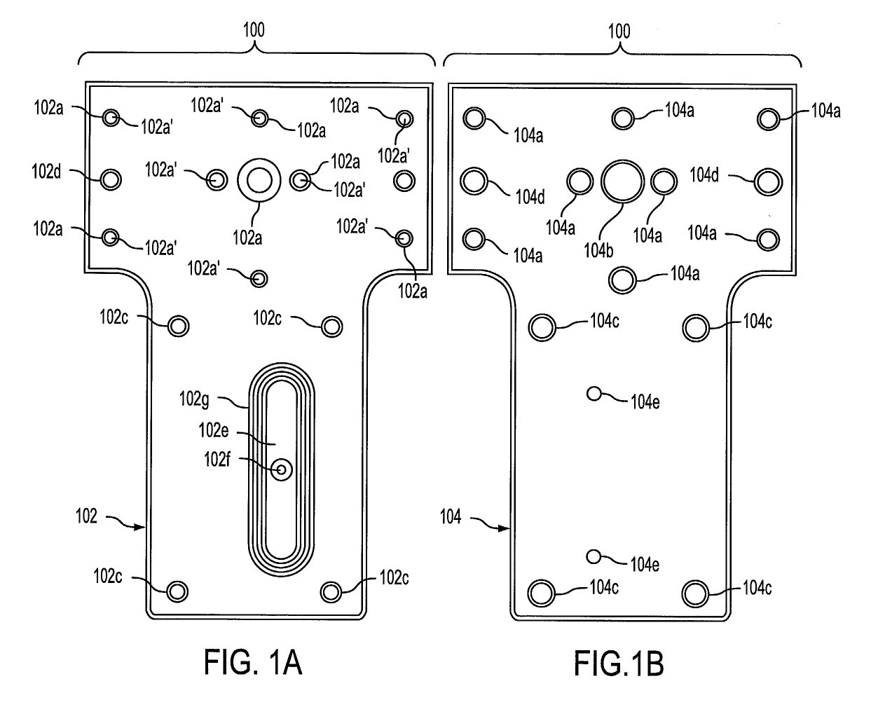

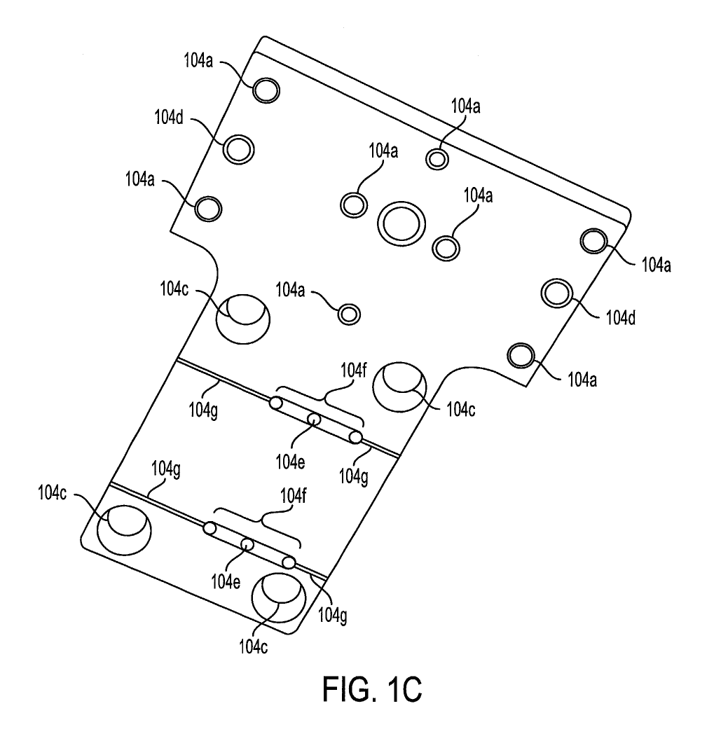

The first chamber part 100 and the second chamber part 200 each may be made from a plurality of joined constituent parts. For example, FIG. 1(a) illustrates a first constituent part 102 of first chamber part 100, and FIGS. 1(b) and 1(b) illustrate opposite faces of a second constituent part 104 of first chamber part 100.

As seen in FIGS. 1(a)-1(c), constituent parts 102 and 104 are similarly shaped in plan and are fixed together using fastening members (such as, without limitation, bolts, screws, and rivets) passed through fastening holes 102c, 104c, respectively. The side of constituent part 104 shown in FIG. 1(b) opposes the side of constituent part 102 shown in FIG. 1(a) when constituent parts 102, 104 are fixed together. Parts 102, 104 each include, respectively, an actuator bore 102b, 104b through which push-pull actuator 302 passes, and dowel holes 102a, 104a in which alignment dowels 102a′ are mounted. The alignment dowels 102a′ outwardly extend from first chamber part 100 from the side of constituent part 104 shown in FIG. 1(c).

Constituent part 102 includes an elongate trench 102e formed therein. For example, constituent part 102 may be made from a metallic material, and trench 102e may be formed therein by milling or the like. Trench 102e includes at least one fluid port 102f extending through the thickness of constituent part 102. Preferably, a sealing member 102g is provided about a periphery of trench 102e, such as a resilient sealing ring mounted in a peripheral groove extending about a periphery of trench 102e. The sealing member 102g is preferably made from a resilient material, such as VYTON™, that resists chemical reaction with a cleaning fluid used in the apparatus.

When constituent parts 102 and 104 are fixed together, trench 102e is aligned with the at least one fluid port 104e extending through the thickness of constituent part 104. In a desirable arrangement according to an embodiment of the present invention, one fluid port 102f and a number of fluid ports 104e corresponding to the number of cleaning chambers present are provided. Trench 102e with fluid port 102f formed therein desirably provides a single fluid input point for feeding a cleaning fluid into the apparatus, thereby simplifying the construction and operation of the apparatus. The cleaning fluid fed through fluid port 102f is distributed to the at least one fluid port 104e because trench 102e extends so as to be in communication with all of the fluid ports 104e provided. It will therefore be appreciated that the length of trench 102e corresponds to the number of fluid ports 104e provided in constituent part 104. The sealing member 102g provided around trench 102e helps to prevent cleaning fluid from leaking out of trench 102e between constituent parts 102, 104.

The side of constituent part 104 shown in FIG. 1(c) includes at least one cleaning chamber trench 104f in which a corresponding fluid port 104e (discussed above) is located. The number of cleaning chamber trenches 104f provided in the apparatus corresponds to the number of cleaning chambers provided in the apparatus. If more than one cleaning chamber trench 104f is provided, each cleaning chamber trench 104f is generally parallel to the other cleaning chamber trenches 104f. Preferably, the cleaning chamber trenches 104f are spaced apart from each other so as to not interfere with each other during processing. In one example of the present invention, two cleaning chamber trenches 104f are provided.

Each cleaning chamber trench 104f includes alignment grooves 104g extending from opposite ends of the cleaning chamber trench 104f, in line with cleaning chamber trench 104f. The alignment grooves 104g are sized so as to be able to receive an optical fiber being cleaned therein, and they extend from a respective cleaning chamber trench 104f to an edge of first chamber part 100. The provision of alignment grooves 104g running continuously with cleaning chamber trench 104f helps to protect an elongate member being cleaned, such as an optical fiber, from being crushed between respective opposing faces of the first and second chamber parts 102, 104.

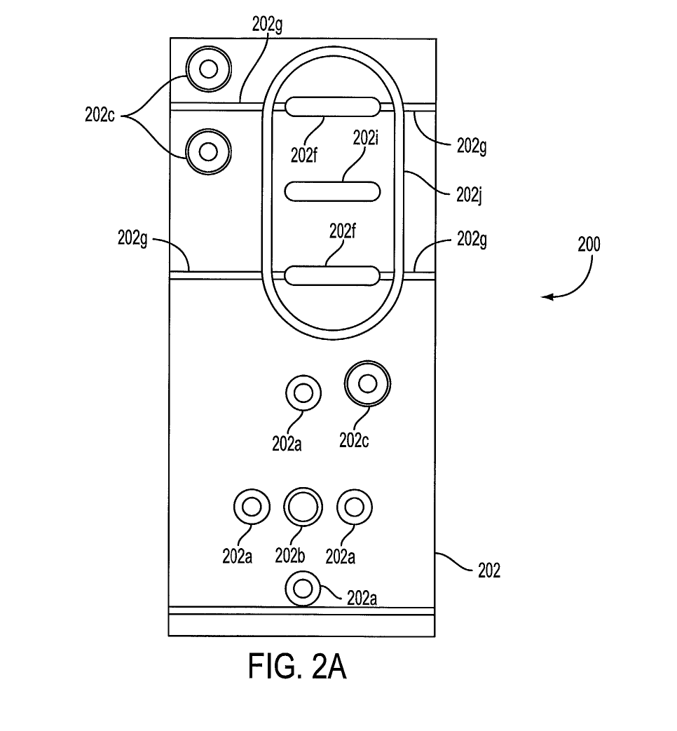

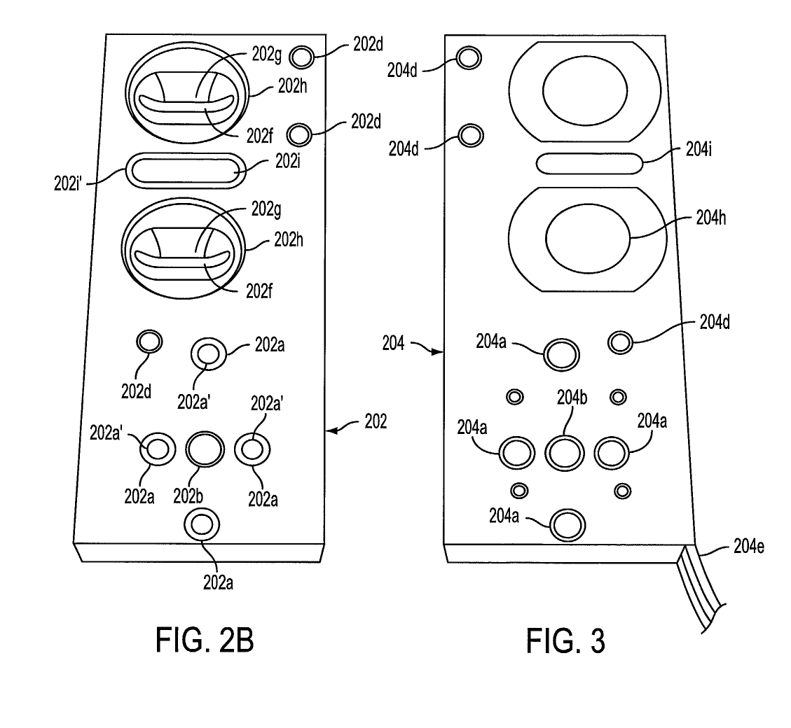

FIG. 2(a) illustrates a side of second chamber part 200 that faces the side of first chamber part 100 illustrated in FIG. 1(c). Second chamber part 200 may also consist of constituent components, such as constituent components 202, 204, as seen in FIGS. 2(a), 2(b), and 3. FIGS. 2(a) and 2(b) illustrate opposite sides of constituent part 202, and FIG. 3 illustrates a side of constituent part 204 that faces the side of constituent part 202 illustrated in FIG. 2(b) when constituent parts 202, 204 are fixed together (for example, using bolts, nuts or the like 202c that pass through fastening holes 202d and 204d, respectively.

The constituent parts 202, 204 include actuator bores 202b, 204b formed therethrough, corresponding to actuator bores 102b, 104b formed in first chamber part 100. The constituent parts 202, 204 also include dowel holes 202a, 204a formed therethrough, aligned with dowel holes 102a, 104a in first chamber part 100. As can be seen in FIGS. 2(a) and 2(b), dowel holes 202a may include conventional sleeve bearings 202a′ or the like therein to facilitate travel of second chamber part 200 on dowels 102a′.

Constituent part 202 includes a cleaning chamber slit 202f formed therein, substantially corresponding in size and location to the cleaning chamber trench 104f formed in first chamber part 100. As seen in FIG. 2(b), a concavity 202g is formed in the opposite side of constituent part 202 in a location corresponding to cleaning chamber slit 202f. In use, therefore, cleaning fluid supplied via cleaning chamber trench 104f passes through cleaning chamber slit 202f when cleaning chamber trench 104f and cleaning chamber slit 202f are in opposition. As a result, a quantity of cleaning fluid is held in the space defined by concavity 202g.

A resilient sealing member 202j is provided around a region including cleaning chamber slit 202f and fluid outlet slit 202i. For example, a resilient sealing ring or the like may be disposed in a groove or the like formed in constituent part 202 as illustrated in FIG. 2(a).

The concavity 202g is located in a region 202h. The region 202h corresponds to a corresponding ultrasonic transducer 204h, that is powered by a conventional power source. Transducer 204h may, for example, include an oscillating disc. Preferably, transducer 204h is driven in oscillation so as to cause cavitation in the cleaning fluid, whereby small bubbles that enhance the cleaning action are formed. In the regard, the transducer 204h is operable at frequencies between about 40 kHz and about 200 kHz.

In an alternative arrangement, one ultrasonic transducer may be provided to act on a plurality of cleaning chambers.

However, it is desirable to drive the transducer 204h at a resonance frequency of the oscillating disc for the sake of efficiency. The oscillating disc may have a radial mode of vibration and a thickness mode. A 20 mm diameter disc, for example, may be driven in its radial mode at about 103 kHz. Different diameter discs, of course, will have different resonant frequencies, determinable according to known principles of physics. Power cable 204e supplies electrical power to the transducer 204h.

A fluid outlet port 204i is provided in constituent part 204, for example. Fluid outlet port 204i is connected to a pump and/or a vacuum device, as described in more detail below. Fluid outlet port 204i is in substantially sealed communication with fluid outlet slit 202i in constituent part 202. The provision of a single fluid outlet port from the apparatus is advantageous because multiple fluid output lines can be avoided. A sealing member 202i′ may be provided about a periphery of fluid outlet slit 202i in order to help prevent cleaning fluid from leaking between fluid outlet slit 202i and fluid outlet port 204i between constituent parts 202, 204.

Accordingly, cleaning fluid is drawn into fluid outlet slit 202i substantially only from the region between first and second chamber parts 100, 200 defined by resilient sealing member 202j, as seen in FIG. 2(a). It is not necessary, according to the present invention, to completely prevent cleaning fluid from leaking between first and second chamber parts 100, 200, but it is relatively more desirable to limit such leakage.

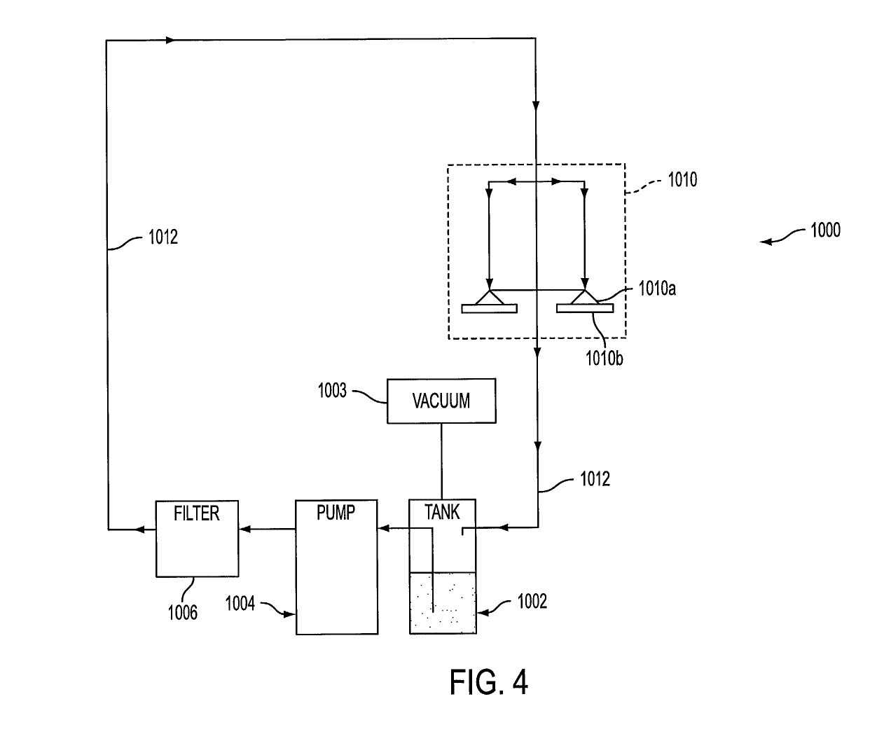

FIG. 4 is a schematic representation of cleaning apparatus 1000. In this example, cleaning fluid is moved in a closed circuit so as to be recycled. Thus, the apparatus 1000 may include a cleaning fluid supply tank 1002 containing a quantity of a cleaning fluid. Examples of cleaning fluids usable according to the present invention include, without limitation, isopropyl alcohol, methyl alcohol, ethyl alcohol, and acetone. About 500 ml of cleaning fluid are present in the system in a typical arrangement. In some cases, it may be useful (although not necessary) to provide a desiccant, such as anhydrous silica gel in the tank to absorb any water present in the system.

A fluid pump 1004 is also arranged in the circuit so as to move the cleaning fluid through the circuit. A conventional fluid pump can used according to the present invention. In a working example of the present invention, a 12 volt DC motor with a 20 psi output is used.

In addition, a vacuum device 1003 may be provided in the circuit, if desired. Vacuum device 1003 may be used to provide a slight vacuum in the circuit to further urge the cleaning fluid therethrough. In addition, a vacuum applied to the space between first and second chamber parts 100, 200 that is substantially sealed by sealing member 202j helps to retard leakage and increase the drawing of cleaning fluid into fluid outlet slit 202i.

Because the cleaning fluid is recycled, it is useful but not necessary to provide a conventional fluid filter apparatus 1006 in the circuit to filter the cleaning fluid before it is used in a new cleaning process. Filter 1006 may be a small-pore filter, such as a TEFLON™ membrane filter with, for example, a 0.2 micron pore size.

The portion of the apparatus in FIG. 4 indicated by a broken line box 1010 schematically represents the apparatus illustrated with reference to FIGS. 1-3, 5, and 6 and described in detail herein. It generally illustrates an example of a cleaning fluid supply being split between multiple (here, 2) cleaning chambers according to the present invention. The representation at 1010a represents the volume of cleaning fluid held in concavities 202g (see, for example, FIG. 2(b)), driven to oscillate by schematically illustrated transducers 1010b.

The elements of the apparatus, such as tank 1002, pump 1004, filter 1006, and fluid lines 1012 are generally made of materials that are non-reactive or otherwise chemically resistant to the cleaning fluid being used. For example, tank 1002 may be lined with TEFLON™ and tank 1002 may be made from an appropriate polypropylene composition. Fluid lines 1012 may be made from, for example, VYTON™.

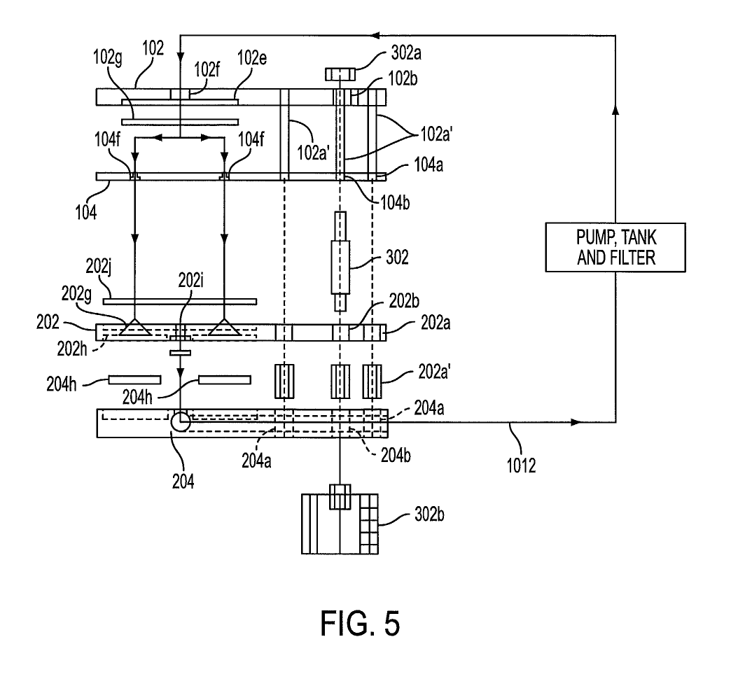

FIG. 5 is an exploded view illustrating the structures illustrated in FIGS. 1-4 and described hereinabove. Corresponding features discussed elsewhere herein are given the same reference numeral, and a detailed description thereof is not repeated.

The structure of an exemplary actuator mechanism can be more clearly seen in FIG. 5. Specifically, a push-pull rod 302 is passed through actuator bores 102b, 104b in first chamber part 100, and through actuator bores 202b, 204b in second chamber part 200. A distal end of push-pull rod 302 is fixed against first chamber part 100 by a threaded nut or the like 302a fixed to push-pull rod 302. A proximal end of push-pull rod 302 is connected to an actuator drive, such as a pneumatic source 302b.

FIGS. 6(a)-6(e) illustrate an example operation of apparatus 1000. As seen in FIG. 6(a), a pair of elongate members 2000, such as optical fibers, are provided. In FIGS. 6(a)-6(e), the elongate members 2000 extend perpendicular to the page. FIGS. 6(a), 6(b), 6(d), and 6(e) show the apparatus 1000 in an example of an “open state,” and FIG. 6(c) shows the apparatus 1000 in an example of a “closed state.”

At an initial stage, as seen in FIG. 6(a), apparatus 1000 is off to one side (in a direction generally perpendicular to elongate members 2000) of elongate members 2000, with first and second chamber parts 100, 200 separated.

In FIG. 6(b), the elongate members 2000 and cleaning apparatus 1000 are moved relative to each other in a known manner so that elongate members 2000 are interposed between the still-separated first and second chamber parts 100, 200. In particular, each elongate member is substantially aligned with corresponding trenches 104f and alignment grooves 104g in first chamber part 100 and slits 202f and alignment grooves 202g in second chamber part 200.

In FIG. 6(c), actuator 300 is driven to move first and second chamber parts 100, 200 toward each other. For example, pneumatic source 302b is actuated to pull push-pull rod 302 towards a closed position. Because a distal end of push-pull rod 302 is engaged with first chamber part 100, first chamber part 100 is pulled towards second chamber part 200. The force with which first and second chamber parts 100, 200 press against each other (under the influence of actuator 300) is, in one working example, between 80-90 psi. After first and second chamber parts 100, 200 are engaged, cleaning fluid is introduced into the cleaning chambers defined therein and the ultrasonic transducers are activated for a required period of time. Because of the structure of apparatus 1000, the elongate members 2000 are cleaned using only the ultrasonically excited cleaning fluid, and no physical contact with another cleaning structure (e.g., wiping with a cloth) is needed to clean the elongate members 2000. Therefore, the elongate members 2000 are protected from scratching and the like.

In addition, it may be desirable to clean only an intermediate portion of the elongate members 2000, excluding the distal end portion. For example, it is possible that the distal ends of elongate members 2000 may be relatively more subject to damage than an intermediate portion of the elongate members. In the case of optical fibers, for example, an intermediate portion of the optical fibers is usually protected by a protective coating or sheath. Subsequently, cleaving is performed within the cleaned intermediate portion.

In an example of the present invention using 20 mm diameter transducers, cleaning chambers about 3.5 mm wide and about 16 mm long, and an oscillating frequency of about 103 kHz, it has been found that an elongate member such as a stripped optical fiber can be suitably cleaned in about 15 seconds or less, compared to about 30 seconds in a conventional ultrasonic cleaning tub. When this halving of cleaning time is multiplied over a total throughput, considerable time savings can be realized.

In FIG. 6(d), after a cleaning process is completed, the first and second chamber parts 100, 200 are separated by, for example, the action of actuator 300. For example, pneumatic source 302b may be operated to push push-pull rod 302 outwardly, thereby forcing first chamber part 100 away from second chamber part 200. If desired, the pump 1002 and/or vacuum 1003 may be operated in a manner to evacuate some or all of the cleaning fluid in the cleaning chamber(s) before the first and second chamber parts are moved apart from each other, thereby further reducing spillage and the like.

Finally, in FIG. 6(e), cleaning apparatus 1000 is again withdrawn to one side relative to elongate members 2000 so that elongate members 2000 can be utilized or further processed as may be needed.

Thus, while there have been shown and described features of the present invention as applied to preferred embodiments thereof, it will be understood that various omissions and substitutions and changes in the form and details of the devices illustrated, and in their operation, and in the method illustrated and described, may be made by those skilled in the art without departing from the spirit of the invention as broadly disclosed herein.

What is claimed is:

1. An optical fiber cleaning apparatus comprising:
a cleaning chamber substantially isolated from a surrounding environment for holding a fluid;
an ultrasonic excitation source arranged to ultrasonically excite a fluid in said cleaning chamber; and
a fluid feeding system for moving a fluid into and out of said cleaning chamber.

2. The apparatus according to claim 1, wherein said cleaning chamber is elongate and at least partly defined by first and second selectively engageable chamber parts.

3. The apparatus according to claim 2, wherein said first and second chamber parts are independent members.

4. The apparatus according to claim 2, wherein said first and second chamber parts are hingedly attached.

5. The apparatus according to claim 1, wherein said fluid feeding system comprises a fluid pump fluidically connected to said cleaning chamber.

6. The apparatus according to claim 1, wherein said fluid feeding system is a closed circuit.

7. The apparatus according to claim 6, wherein said fluid feeding system comprises a fluid pump arranged in said closed circuit.

8. The apparatus according to claim 7, said fluid feeding system further comprising a fluid filter arranged in said closed circuit.

9. The apparatus according to claim 7, said fluid feeding system further comprising a vacuum generating device connected to said closed circuit so as to draw a fluid through the closed circuit.

10. The apparatus according to claim 6, said fluid feeding system further comprising a fluid supply chamber.

11. The apparatus according to claim 1, wherein said ultrasonic excitation source is located adjacent to said cleaning chamber and constructed and arranged to oscillate between about 40 kHz and about 200 kHz.

12. The apparatus according to claim 11, wherein said ultrasonic excitation source is constructed and arranged to oscillate at about 103 kHz.

13. The apparatus according to claim 3, wherein said ultrasonic excitation source is mounted in said second chamber part.

14. The apparatus according to claim 1, comprising a plurality of said cleaning chambers, a plurality of said ultrasonic excitation sources for ultrasonically exciting a fluid in respective ones of said plurality of cleaning chambers, said fluid feeding system moving a fluid into and out of each said cleaning chamber.

15. The apparatus according to claim 2, wherein said first and second chamber parts include first and second opposing faces, respectively.

16. The apparatus according to claim 15, wherein said first and second faces include first and second concavities formed therein, respectively, said first and second concavities being located in substantial alignment when said first and second chamber parts are engaged so as to define said cleaning chamber.

17. The apparatus according to claim 16, wherein at least one of said first and second faces includes an annular sealing member disposed thereon and arranged so as to substantially seal said cleaning chamber from an exterior.

18. The apparatus according to claim 17, wherein said sealing member is made from a material that is chemically non-reactive with a fluid in the apparatus.

19. The apparatus according to claim 2, wherein said ultrasonic excitation source is associated with only one of said first and second chamber parts.

20. The apparatus according to claim 16, wherein one of said first and second concavities includes a fluid supply port and the other of said first and second concavities includes a fluid outlet port.

21. The apparatus according to claim 6, wherein one of said first and second chamber parts includes a fluid supply port for the chamber part and one of said first and second chamber parts includes a fluid outlet port for the chamber part.

22. The apparatus according to claim 21, wherein the number of fluid supply ports is different than the number of fluid outlet ports.

23. The apparatus according to claim 6, wherein one of said first and second chamber parts includes a fluid supply port for the chamber part and the other of said first and second chamber parts includes a fluid outlet port for the chamber part.

24. The apparatus according to claim 21, wherein said fluid feeding system comprises fluid lines connected to said fluid supply port and said fluid outlet port.

25. The apparatus according to claim 23, wherein said fluid feeding system comprises a vacuum device arranged in said closed circuit to urge a fluid out of said cleaning chamber.

26. The apparatus according to claim 1, wherein said ultrasonic excitation source is an ultrasonic transducer disc.

27. The apparatus according to claim 26, wherein said ultrasonic transducer disc is constructed and arranged to oscillate at a resonance frequency of the ultrasonic transducer disc in its thickness mode.

28. The apparatus according to claim 26, wherein said ultrasonic transducer disc is constructed and arranged to oscillate at a resonance frequency of the ultrasonic transducer disc in its radial mode.

29. The apparatus according to claim 2, further comprising an actuator mechanism for selectively moving said first and second chamber parts between an open state and a closed state.

30. The apparatus according to claim 29, wherein said actuator mechanism is pneumatic.

31. The apparatus according to claim 30, wherein said actuator mechanism is a push-pull rod.

32. A method for cleaning a portion of an optical fiber member comprising:
disposing the portion of the optical fiber in a cleaning chamber substantially isolated from a surrounding environment; and
cleaning the portion of the optical fiber with an ultrasonically excited cleaning fluid in the cleaning chamber.

33. The method according to claim 32, wherein cleaning the portion of the elongate member comprises contacting the portion of the elongate member only with the cleaning fluid.

34. The method according to claim 32, wherein disposing the portion of the elongate member in a cleaning chamber comprises placing only an intermediate portion of the optical fiber in the cleaning chamber.

35. The method according to claim 32, wherein the ultrasonically excited cleaning fluid is driven at a frequency between about 40 kHz and about 200 kHz.

36. The method according to claim 35, wherein the ultrasonically excited cleaning fluid is driven at a frequency of about 103 kHz.

37. The method according to claim 32, wherein the cleaning fluid is one of isopropyl alcohol, methyl alcohol, ethyl alcohol, and acetone.

38. The method according to claim 32, further comprising cycling the cleaning fluid into and out of the cleaning chamber.

39. The method according to claim 38, wherein cycling the cleaning fluid comprises pumping the cleaning fluid.

40. The method according to claim 38, wherein cycling the cleaning fluid into and out of the cleaning chamber comprises cycling the cleaning fluid through a closed circuit.

41. The method according to claim 40, wherein cycling the cleaning fluid through a closed circuit comprises filtering the cleaning fluid prior to reintroducing the cleaning fluid into the cleaning chamber.

42. The method according to claim 38, wherein cycling the cleaning fluid into and out of the cleaning chamber comprises drawing the cleaning fluid using a vacuum device.

43. The method according to claim 39, wherein cycling the cleaning fluid into and out of the cleaning chamber comprises drawing the cleaning fluid using a vacuum device.

44. The method according to claim 32, wherein disposing the portion of the elongate member in a cleaning chamber comprises:
disposing the portion of the elongate member between first and second chamber parts, each chamber part at least partly defining the cleaning chamber; and
moving the first and second chamber parts into a closed state so as to dispose the portion of the elongate member in the resultant cleaning chamber.

45. The method according to claim 44, wherein the first and second chamber parts are independent from each other, moving the first and second chamber parts into a closed state comprising moving the first and second chamber parts linearly towards each other.

46. The method according to claim 44, wherein the first and second chamber parts are hingedly attached to each other, moving the first and second chamber parts into a closed state comprising pivotably moving the first and second chamber parts towards each other.

47. The method according to claim 44, wherein disposing the portion of the elongate member between the first and second chamber parts comprises moving the portion of the elongate member and the first and second chamber parts relatively towards each other.

48. The method according to claim 47, further comprising maintaining the elongate member in the same plane as the direction of relative movement between the portion of the elongate member and the first and second chamber parts.

49. The method according to claim 32, further comprising substantially emptying the cleaning chamber of cleaning fluid after cleaning the portion of the elongate member.

50. A method for cleaning an intermediate portion of a stripped optical fiber, comprising:
disposing only an intermediate portion of a stripped optical fiber in a cleaning chamber; and
cleaning the intermediate portion of the stripped optical fiber with an ultrasonically excited cleaning fluid introduced into the cleaning chamber.

51. The method according to claim 50, comprising cleaning the intermediate portion of the stripped optical fiber only with an ultrasonically excited cleaning fluid introduced into the cleaning chamber.

52. The method according to claim 50, wherein cleaning the intermediate portion of the stripped optical fiber comprises cleaning the intermediate portion of the stripped optical fiber in a cleaning chamber substantially isolated from a surrounding environment.

53. The method according to claim 50, wherein the ultrasonically excited cleaning fluid is an alcohol or acetone.

54. The method according to claim 50, wherein disposing an intermediate portion of a stripped optical fiber in a cleaning chamber includes moving the intermediate portion of the stripped optical fiber and the cleaning chamber relatively towards each other.

55. The method according to claim 54, including maintaining the intermediate portion of the stripped optical fiber in the same plane as the direction of relative movement between the intermediate portion of the stripped optical fiber and the cleaning chamber.

56. The method according to claim 50, comprising disposing only respective intermediate portions of a plurality of stripped optical fibers in a corresponding plurality of cleaning chambers, and cleaning the plurality of intermediate portions of the stripped optical fibers with an ultrasonically excited cleaning fluid in the respective cleaning chambers.

57. An apparatus for cleaning an optical fiber, comprising:
a cleaning chamber substantially isolated from a surrounding environment for holding a fluid, said cleaning chamber including a fluid inlet and a fluid outlet;
an ultrasonic excitation source arranged to ultrasonically excite a fluid in said cleaning chamber; and
a fluid feeding system fluidically connected with said fluid inlet and said fluid outlet for moving a fluid into and out of said cleaning chamber.
